(19) United States
(12) Patent Application Publication
(10) Pub. No.: US 2007/0236020 A1
(43) Pub. Date: Oct. 11, 2007

(54) System for generation electric power

(76) Inventor: John M. Ahearn, Baker, FL (US)

Correspondence Address: JOHN M. AHEARN, 5467 OLD RIVER DR., BAKER, FL, 32531, US

(21) Appl. No.: 11/645,314

(22) Filed: Dec. 26, 2006

Related U.S. Application Data
(60) Provisional application No. 60/789,259, filed on Apr. 6, 2006.

(51) Int. Cl. F03B 13/00; F03B 13/10; H02P 9/04

(52) U.S. Cl. 290/43

(57) ABSTRACT

This patent that is being applied for brings together and combines mean long and proven electric components in to a SYSTEM that will be able to produce electric power from Fast moving water, when mounted on the ocean bottom such as in the Gulf Stream off the coast of Florida or the Bay of Fundy up in Canada

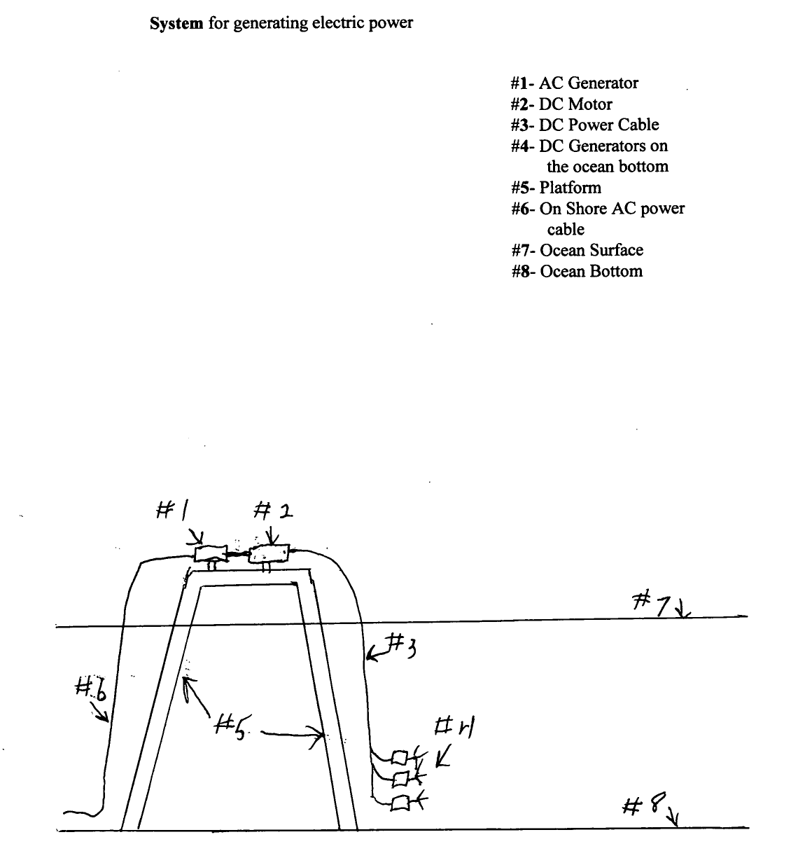

A group of DC generators connected in parallel mounted on the ocean bottom and of a size that can be brought to the surface for service and repair. These units will maintained by a vessel that is equipped with a remote controlled retriever. The number of units will depend on the megawatts output of the platform mounted AC generator, that is turned by the DC motor that is driven by the DC generators.

There will be three DC motor, AC generator units on each platform, controlled by a mostly automatic control panel, so as to maintain the 60 cycle speed of the AC generators that is necessary to be compatible with the on shore system.

The control panel will determine and adjust the out put of the shunt wound DC generators as the ocean current changes speed and can add to the group the spears that are on hand, should it be come also necessary, to maintain the AC generator's speed.

In the event that the current slows below the point that the 60 cycle can not be maintained, one of the three units will be shut down, there by making a valuable the set OF DC generators, that were running it, to keep the other two units up to speed.

1. What I clam as my invention is a SYSTEM for generating electric power from fast moving water current, such as the Gulf Stream, or up in the Bay of Fundy.
This is accomplished through the use of a group of DC generators, in parallel mounted on the ocean bottom and turned by the current, the energy which is then by electric cable transported up to the surface an a platform mounted large DC motor that will turn a large AC generator, that will supply power at 60 cycle to the on shore system, by way of an under water cable.
